(19) United States
(12) Patent Application Publication
(10) Pub. No.: US 2026/0017602 A1
(43) Pub. Date: Jan. 15, 2026

(54) BUSINESS INFORMATION GENERATION

(71) Applicants: Shanghai Gewu Zhiyuan Network Technology Co., Ltd., Shanghai (CN); Lemon Inc., Grand Cayman (KY)

(72) Inventors: Qiaoqiao Pan, Beijing (CN); Dingwei Qian, Beijing (CN); Peicao Shi, Beijing (CN); Hui Fan, Beijing (CN); Kai Liu, Beijing (CN); Jiabin Wei, Beijing (CN); Chuangzhao Li, Beijing (CN); Huiling Mu, Beijing (CN); Qiang Zhang, Beijing (CN); Zhitian Fu, Beijing (CN); Binglin Zhang, Beijing (CN); Lei Wang, Los Angeles, CA (US); Qiong Wu, Beijing (CN)

(21) Appl. No.: 19/024,468

(22) Filed: Jan. 16, 2025

(30) Foreign Application Priority Data
Jul. 12, 2024 (CN) 202410940417.X

(51) Int. Cl. G06Q 10/0834; G06Q 10/10

(52) U.S. Cl. CPC G06Q 10/08345; G06Q 10/10

(57) ABSTRACT

Embodiments of the disclosure provide a method, apparatus, electronic device, medium, and product for generating business information. In the method, business attribute information input based on a business information input component is acquired, and a business resource generating template is matched based on the business attribute information; based on a business attribute information item in the business resource generating template, a business attribute information value corresponding to the business attribute information item is acquired, and business resource information is generated based on the business attribute information value; wherein the business resource generating template is configured and generated based on at least one of the following: a predetermined business attribute information item, an attribute information operation identification, or an attribute arithmetic function.

### CROSS-REFERENCE

This application claims priority to Chinese Patent Application No. 202410940417.X, filed on Jul. 12, 2024 and entitled ‘METHOD, APPARATUS, ELECTRONIC DEVICE, MEDIUM AND PRODUCT FOR GENERATING BUSINESS INFORMATION’, which is incorporated herein by reference in its entirety.

### FIELD

Embodiments of the present disclosure relate to the field of computer technologies, and in particular, to a method, apparatus, electronic device, medium, and product for generating business information.

### BACKGROUND

In some business scenarios, it is necessary to determine target business information that is subject to a plurality of dimensions of business information, e.g., determining logistics cost as business resource information in the logistics business. In the process of determining the target business information, the information determination logic is numerous and complex, therefore, it is necessary to maintain multi-dimensional information fields to distinguish different information generation logic.

However, at present, the required information fields are mostly defined through protocol interactions, and the maintenance of different information fields and corresponding information generation logic functions is decentralized. This leads to the disadvantages of a large number of code repositories involved in the process of generating target business information, complex changes when adding new information dimensions, and difficulties in the maintenance of each system.

### SUMMARY

Embodiments of the present disclosure provide a method, apparatus, electronic device, medium, and product for generating business information that may generate business resource information by means of a business resource generating template obtained in advance by configuring a predetermined business attribute information item having a unified data structure, reducing the complexity of implementing the business resource template configuration and the related data maintenance, and making the process of generating business resource information more efficient and stable.

According to a first aspect, embodiments of the present disclosure provide a method of business information generation. The method includes: acquiring business attribute information input based on a business information input component, and matching a business resource generating template based on the business attribute information; wherein the business attribute information includes a corresponding business attribute information item and a business attribute information value; and based on a business attribute information item in the business resource generating template, acquiring a business attribute information value corresponding to the business attribute information item, and generating business resource information based on the business attribute information value; wherein the business resource generating template is configured and generated based on at least one of the following: a predetermined business attribute information item, an attribute information operation identification, or an attribute arithmetic function; the predetermined business attribute information item is pre-configured based on a predetermined attribute data structure; the attribute arithmetic function is pre-constructed based on the predetermined business attribute information item; and the attribute information operation identification is configured to indicate that an arithmetic operation corresponding to the attribute information operation identification is performed on a business attribute information value of a predetermined business attribute information item corresponding to the attribute information operation identification.

According to a second aspect, embodiments of the present disclosure provide an apparatus for generating business information. The apparatus includes: a business attribute information acquiring module configured to acquire business attribute information input based on a business information input component, and match a business resource generating template based on the business attribute information; wherein the business attribute information includes a corresponding business attribute information item and a business attribute information value; and a target business information generating module configured to acquire, based on a business attribute information item in the business resource generating template, a business attribute information value corresponding to the business attribute information item, and generate business resource information based on the business attribute information value; wherein the business resource generating template is configured and generated based on at least one of the following: a predetermined business attribute information item, an attribute information operation identification, or an attribute arithmetic function; the predetermined business attribute information item is pre-configured based on a predetermined attribute data structure; the attribute arithmetic function is pre-constructed based on the predetermined business attribute information item; and the attribute information operation identification is configured to indicate that an arithmetic operation corresponding to the attribute information operation identification is performed on a business attribute information value of a predetermined business attribute information item corresponding to the attribute information operation identification.

According to a third aspect, embodiments of the present disclosure further provides an electronic device. The electronic device includes: one or more processors; and a storage device for storing one or more programs, the one or more programs, when executed by the one or more processors, causing the one or more processors to implement the method of business information generation of the embodiments of the present disclosure.

According to a fourth aspect, embodiments of the present disclosure further provides a storage medium including a computer program, characterized in that the computer program, when executed by a processor, implements the method of business information generation of any of the embodiments of the present disclosure.

According to a fifth aspect, an embodiment of the present disclosure further provides a computer program product, including a computer program, wherein the computer program implements, when being executed by a processor, the business information generation method according to any of the embodiments of the present disclosure.

According to embodiments of the present disclosure, business attribute information input based on a business information input component is acquired, and a business resource generating template is matched based on the business attribute information; wherein the business attribute information includes a corresponding business attribute information item and a business attribute information value; and based on a business attribute information item in the business resource generating template, a business attribute information value corresponding to the business attribute information item is acquired, and business resource information is generated based on the business attribute information value; wherein the business resource generating template is configured and generated based on at least one of the following: a predetermined business attribute information item, an attribute information operation identification, or an attribute arithmetic function. The technical solution of the embodiments of the present disclosure solves the problem of complex configuration and maintenance of business information generation templates, and may configure resource generation templates based on pre-configured business attribute metadata for generating business resource information, which improves the efficiency of acquiring business information, and also reduces the complexity of implementing the business resource templates configuration and the maintenance of related data.

### BRIEF DESCRIPTION OF THE DRAWINGS

The above and other features, advantages, and aspects of various embodiments of the present disclosure will become more apparent with reference to the following detailed description taken in conjunction with the accompanying drawings. The same or like reference signs represent the same or like elements throughout the drawings, it being understood that the drawings are illustrative and that the elements and primaries are not necessarily drawn to scale.

FIG. 1 is a schematic flowchart of a method of business information generation according to an embodiment of the present disclosure;

FIG. 2 is a schematic flowchart of a method of business information generation according to an embodiment of the present disclosure;

FIG. 3 is a schematic flowchart of a method of business information generation according to an embodiment of the present disclosure;

FIG. 4 is a schematic diagram of a business attribute information item configuration page according to an embodiment of the present disclosure;

FIG. 5 is a schematic diagram of a nested configuration of a business attribute information value source of a business attribute information item provided by an embodiment of the present disclosure;

FIG. 6 is a schematic source diagram of a field value corresponding to a predetermined business attribute information item provided by an embodiment of the present disclosure;

FIG. 7 is a schematic configuration diagram of a business resource generating template in different configuration scenarios provided by embodiments of the present disclosure;

FIG. 8 is a schematic structural diagram of an apparatus for generating business information according to an embodiment of the present disclosure;

FIG. 9 is a schematic structural diagram of an electronic device according to an embodiment of the present disclosure.

### DETAILED DESCRIPTION

Embodiments of the present disclosure will be described in more detail below with reference to the accompanying drawings. While certain embodiments of the present disclosure are shown in the drawings, it is to be understood that the present disclosure may be implemented in various forms and would not be construed as limited to the embodiments set forth herein. Instead, these embodiments are provided for a more thorough and complete understanding of the present disclosure. It would be appreciated that the drawings and embodiments of the present disclosure are for exemplary purposes only and are not intended to limit the scope of the present disclosure.

It would be appreciated that the steps recited in the method embodiments of the present disclosure may be performed in different orders, and/or in parallel. Further, the method embodiments may include additional steps and/or omit performing the illustrated steps. The scope of the present disclosure is not limited in this respect.

As used herein, the term ‘including’ and variations thereof are open-ended, i.e., ‘including but not limited to’. The term ‘based on’ is ‘based at least in part on’. The term ‘one embodiment’ means ‘at least one embodiment’; the term ‘a further embodiment’ means ‘at least one further embodiment’; the term ‘some embodiments’ means ‘at least some embodiments’. The relevant definitions of other terms will be given below.

It would be noted that the concepts such as ‘first’ and ‘second’ mentioned in this disclosure are merely used to distinguish different apparatuses, modules, or units, and are not intended to limit the order or interdependence of the functions performed by these apparatus, modules or units.

It would be noted that the modification of ‘a’ and ‘a plurality’ mentioned in this disclosure is illustrative and not limiting and would be understood by those skilled in the art to mean ‘one or more’ unless the context clearly indicates otherwise.

It would be appreciated that, before the technical solutions disclosed in the embodiments of the present disclosure are used, the types of personal information related to the present disclosure, the usage scope, the usage scenario and the like would be notified to the user in an appropriate manner according to the relevant laws and regulations and obtain the authorization of the user.

For example, in response to receiving an active request from a user, sending prompt information to the user to explicitly prompt the user that the requested operation will require obtaining and using the personal information of the user. Therefore, the user may autonomously select, based on the prompt information, whether to provide personal information to software or hardware such as electronic device, application, server, or storage medium that performing the operation of the technical solution of the present disclosure.

As an optional but non-limiting implementation, in response to receiving the active request of the user, the manner of sending the prompt information to the user may be, for example, in the form of a pop-up window, in which the prompt information is presented in the form of text. In addition, the pop-up window may contain an option control for the user to select ‘agree’ or ‘disagree’ to provide the personal information to the electronic device.

It may be appreciated that the foregoing notification and obtaining a user authorization process is merely illustrative and does not constitute a limitation on implementations of the present disclosure, and further manners of meeting related laws and regulations may also be applied to implementations of the present disclosure.

It may be appreciated that the data involved in the technical solution (including but not limited to the data itself, the obtain or use of the data) would follow the requirements of the corresponding laws and regulations and related regulations.

FIG. 1 is a schematic flowchart of a method of business information generation according to an embodiment of the present disclosure. The embodiment of the present disclosure is applicable to a scenario where target business information is confirmed based on business attribute information of a plurality of dimensions. The method may be executed by an apparatus for generating business information, and the apparatus may be implemented in the form of software and/or hardware. Optionally, the apparatus for generating business information may be implemented by an electronic device, and the electronic device may be a mobile terminal, a PC terminal, a server, or the like.

As shown in FIG. 1, the method of business information generation includes:

S110: Acquire business attribute information input based on a business information input component, and match a business resource generating template based on the business attribute information.

In some business domain, business information, as well as a business management system, may manage, including creating a task, inputting task information, generating task information, and querying task information. Therein, the task information generation may be target business information generated based on at least one business attribute information input by the user.

For example, within the field of logistics and transport business, in order to implement efficient automated calculation of freight charges, a logistics resource information generation template may be configured based on the logistics information management system in advance. Based on the input logistics-related business attribute information in accordance with the corresponding logistics resource information generation template, cost-related information for a logistics order is determined.

Therein, the business attribute information may be information related to a description of the business and may be attribute information of any of the task description dimensions. The business attribute information may include a corresponding business attribute information item and a business attribute information value, understood as a field name and a corresponding field value. Taking the logistics business domain as an example, the business attribute information item may include the transport address, the weight of the transport item, the type, the size of the parcel, the transport mode and the transport timeframe, etc., wherein the business attribute information value of each business attribute information item may be shared for the business resource information to be generated, affecting the eventual logistics transport cost.

Therein, the interaction page in which the business information may be input may include a business information input component corresponding to each business attribute information item, and the user may input the business attribute information value by checking, typing, and the like.

After the business attribute information is acquired, a business resource generating template may be matched based on the business attribute information item and/or the business attribute information value corresponding to the respective business attribute information item included therein.

The business resource generating template may correspond to an algorithm for generating business resource information. Different business attribute information items, combinations between more than one business attribute information item, and different business attribute information values may correspond to different business resource generating templates.

S120: Based on a business attribute information item in the business resource generating template, acquire a business attribute information value corresponding to the business attribute information item, and generate business resource information based on the business attribute information value.

Herein, the business resource generating template is configured and generated based on at least one of the following: a predetermined business attribute information item, an attribute information operation identification, or an attribute arithmetic function.

The predetermined business attribute information item is pre-configured based on a predetermined attribute data structure; the attribute arithmetic function is pre-constructed based on the predetermined business attribute information item; and the attribute information operation identification is configured to indicate that an arithmetic operation corresponding to the attribute information operation identification is performed on a business attribute information value of a predetermined business attribute information item corresponding to the attribute information operation identification. That is, the business resource generating template is configured based on a uniformly maintained data structure and a uniformly predetermined business attribute information item. The configuration and management process of the business resource generating template is simplified compared to the separate maintenance of each business processing component, which reduces the difficulty of the corresponding data maintenance, and also makes the configuration of the business resource generating template more flexible, which may be adapted to complex business resource information generation scenarios.

After matching the corresponding business resource generating template, a corresponding business attribute information value may be input into the business resource generating template in accordance with the business attribute information item included in the template, and the corresponding business resource information is obtained by calculating the corresponding algorithm of the business resource generating template.

The way of acquiring the business attribute information value corresponding to the business attribute information item in the business resource generating template may be based on a configuration result of the business attribute information value source in the predetermined attribute data structure corresponding to the business attribute information item. Wherein the configuration result of the business attribute information value source indicates a manner of acquiring the business attribute information value. The specific manner of acquiring the business attribute information value may be a business attribute information value input by the user through the business information input component, may be a predetermined fixed value of the attribute data, may be an arithmetic output value of an attribute arithmetic function, or may be a value passed in the invocation information of the invocation of the business resource generating template.

According to the technical solutions of the embodiments of the present disclosure, business attribute information input based on a business information input component is acquired, and a business resource generating template is matched based on the business attribute information; wherein the business attribute information includes a corresponding business attribute information item and a business attribute information value; and based on a business attribute information item in the business resource generating template, a business attribute information value corresponding to the business attribute information item is acquired, and business resource information is generated based on the business attribute information value; wherein the business resource generating template is configured and generated based on at least one of the following: a predetermined business attribute information item, an attribute information operation identification, or an attribute arithmetic function. The technical solution of the embodiments of the present disclosure solves the problem of complex configuration and maintenance of a business information generating template, and may generate business resource information by means of a business resource generating template obtained in advance by configuring a predetermined business attribute information item having a unified data structure, reducing the complexity of implementing the business resource template configuration and the related data maintenance, and making the process of generating business resource information more efficient and stable.

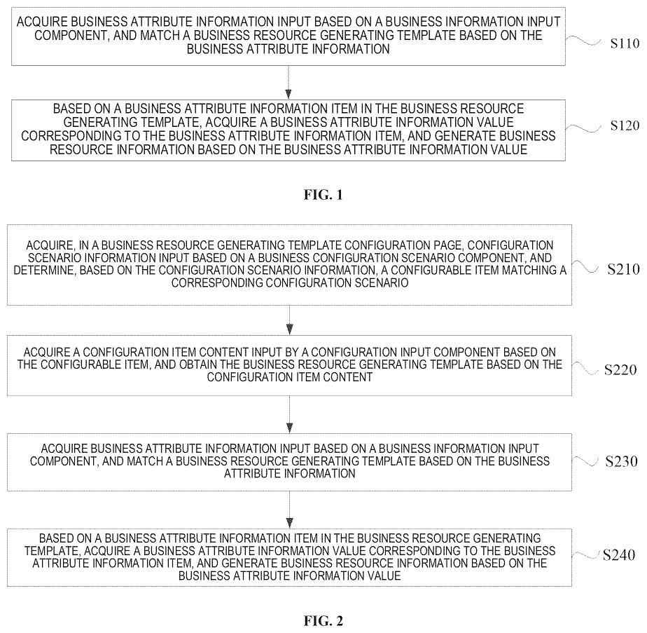

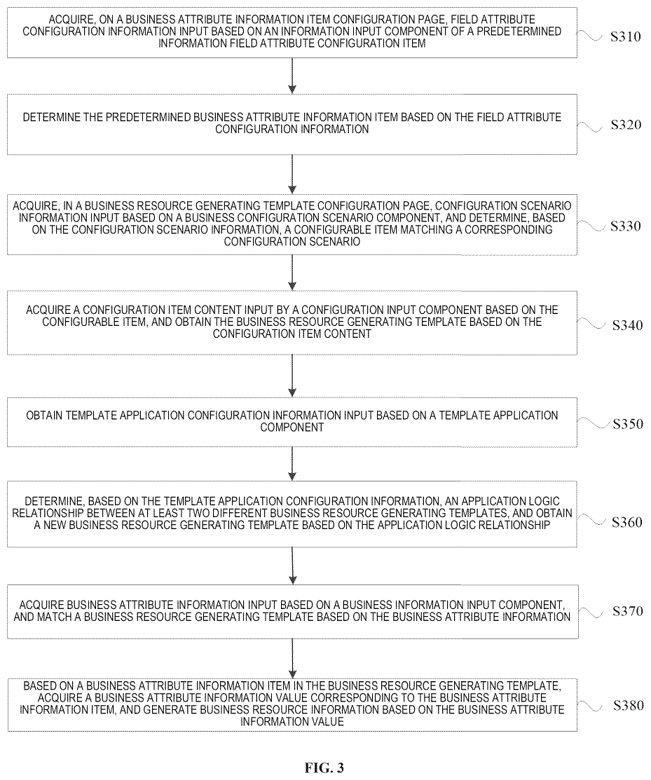

FIG. 2 is a schematic flowchart of a method of business information generation according to an embodiment of the present disclosure. On the basis of the above embodiment, a configuration process of a business resource generating template containing multi-dimensional business attribute information is further explained. The method may be executed by an apparatus for generating business information. The apparatus may be implemented in the form of software and/or hardware. Optionally, the method may be implemented by an electronic device. The electronic device may be a mobile terminal, a PC terminal, a server, or the like.

As shown in FIG. 2, the method of business information generation includes:

S210: Acquire, in a business resource generating template configuration page, configuration scenario information input based on a business configuration scenario component, and determine, based on the configuration scenario information, a configurable item matching a corresponding configuration scenario.

The business resource generating template configuration page may be a business interaction interface for the user to configure and manage the business resource generating template, and may be configured by the relevant business personnel for the business resource generating template based on the logic conducted by the business.

A business configuration scenario may be a scenario for performing business resource generating template configuration based on different dimensions of business attribute information, or a business configuration scenario set up to distinguish between different types of information generation algorithms corresponding to business resource generating templates.

Therein, the configurable item includes a predetermined business attribute information item, an attribute information operation identification and/or an attribute arithmetic function that matches a configuration scenario corresponding to the configuration scenario information. The predetermined business attribute information item is pre-configured based on a predetermined attribute data structure; the attribute arithmetic function is pre-constructed based on the predetermined business attribute information item; and the attribute information operation identification is configured to indicate that an arithmetic operation corresponding to the attribute information operation identification is performed on a business attribute information value of a predetermined business attribute information item corresponding to the attribute information operation identification.

In this embodiment, the business resource generating template configuration page may be divided based on a business information generation scenario, and a corresponding configuration information input page is set respectively for different business configuration scenarios. Therein, different business configuration scenarios may correspond to different configurable item contents, thereby presenting different configuration information input pages.

After selecting a business configuration scenario, the user may, in response to a selection operation in the business configuration scenario, present corresponding business resource information generating template configuration page.

For example, in the field of logistics business, the predetermined business attribute information item is pre-configured based on the predetermined attribute data structure and is the logistics business attribute field metadata needed to maintain the logistics business resource information generating module. For example, the address of the buyer and seller, the weight of the package, the type of transport, the departure and landing ports of the airline company, the out-of-pocket commodity price, and the like. The predetermined attribute data structure may include structural content for describing the definition, structure, source, creation time, modification time, type, applicable configuration scenarios, and other structural contents of the individual logistics attribute fields, which may help the user better understand, manage, and use the data.

The attribute arithmetic function is pre-constructed based on the predetermined business attribute information item, and may be for data of a plurality of predetermined business attribute information items, and the function output result may also correspond to a data value of a type corresponding to one of the plurality of predetermined business attribute information items.

The attribute information operation identification is configured to be used for an arithmetic operation between the predetermined business attribute information items and to output a Boolean-type calculation result. That is, the attribute information arithmetic function and the data object on which the predetermined business attribute information items perform arithmetic operations are all predetermined business attribute information items that have been pre-registered and configured.

The division of business information generating scenarios may be divided by the user based on the actual logistics business scenarios, such as the division of domestic logistics costs, international logistics cost scenarios, the division of regular transport and cold-chain transport; it may also be divided from different billing dimensions, from a single weight, package dimensions or the number of packages and other dimensions; it may also be in accordance with the direction of the different transport routes and other scenarios.

S220: Acquire a configuration item content input by a configuration input component based on the configurable item, and obtain the business resource generating template based on the configuration item content.

In different business configuration scenarios, a user may perform a configuration operation on a predetermined business attribute information item, an attribute information operation identification, and/or an attribute arithmetic function corresponding to the configurable item. It may be to configure a business resource calculation base corresponding to a size range of a predetermined business attribute information value of the predetermined business attribute information item, and it may be to configure a function arithmetic relationship or a Boolean arithmetic logic relationship among the plurality of predetermined business attribute information items.

For example, the predetermined business attribute information item is package net weight, and when the value of package net weight is greater than 5 kg, the corresponding business resource calculation base is 10. For example, in an attribute arithmetic function, the maximum weight value is to be selected among two weight data. Then, the input of the attribute arithmetic function may be a predetermined business attribute information value corresponding to the two predetermined business attribute information items of the actual weight of the package and the weight weighed by the courier, and the output of the attribute arithmetic function is the numerical value of the field type corresponding to the actual weight of the package or the weight weighed by the courier. It is also possible to configure the business resource calculation scale factors corresponding to different transport start and stop intervals.

After the operation of this step, the configuration content corresponding to each configurable item may be acquired, so as to determine the corresponding business resource information generating algorithm based on the operation relationship corresponding to the attribute information operation identification and the algorithm relationship corresponding to the attribute arithmetic function between each of the predetermined business attribute information items, and to implement the configuration of the business resource generating template.

In a business resource generating template configuration page corresponding to a business configuration scenario, the predetermined business attribute information item that may be selected for configuration is a predetermined business attribute information item that matches the business configuration scenario selected by the user. In the logistics business domain, the predetermined business attribute information item may correspond to a logistics attribute field. The field value source of each logistics attribute field may include a variety of ways, such as, for example, an input configuration source, a logistics field assignment source, a function return value source, and a predetermined key value information source. Under different business configuration scenarios, the manner in which the field values of the logistics attribute fields are sourced may also be limited to different manners respectively.

In the process of configuring the business resource generating template, it is also necessary to configure the data source of the business attribute information value corresponding to each predetermined business attribute information item involved in the configurable item, so that the configured business resource generating template may correctly acquire the business attribute information value of the corresponding business attribute information item for calculation when used.

The input configuration source may refer to the direct input of values by the relevant personnel when performing business resource generation. The logistics field assignment source may be to find a logistics attribute field and assign the value of the found logistics attribute field to the corresponding logistics attribute field. The function return value source may be setting the field value source of the logistics attribute field as the result of an attribute algorithm function, which, naturally, needs to be further nested in the configuration of the attribute algorithm function in the data object value source. The predetermined key value information source may be a key value corresponding to a keyword passed from an invocation code that invokes one of the business resource generating templates, wherein the keyword may be an ID of the logistics attribute field.

After steps S210 and S220 the user may configure to obtain one or more business resource generating templates for different business configuration scenarios.

Further, in the configuration process of the business resource generating template, template application configuration information input based on a template application component may also be obtained; an application logic relationship between at least two different business resource generating templates may be determined based on the template application configuration information, and a new business resource generating template may be obtained based on the application logic relationship.

It should be appreciated that in one business resource generation, the business resource information generation is usually performed by integrating the logistics attribute fields of a plurality of dimensions, such as the dimensions of the size, the weight, the quantity, the transport start and end intervals and the types of transported items of the transported packages and further plurality of dimensions, and the different field values of each logistics attribute field may also correspond to different business resource generating templates. Therefore, different business resource generating templates between logistics attribute fields of different dimensions may be configured in a logical relationship.

For example, when the size of the transported package is a first size value and the weight of the transported package is greater than a first weight threshold, the business resource calculation ratio factor is a first factor. Further, for example, when the judgment of the case in which the transport start and end intervals of the transported package are the first transport route is yes and the weight of the transported package is greater than a second weight threshold value, the business resource calculation ratio base is the first base. Thereby, a target business resource generating template containing multi-dimensional information is generated based on a logical relationship between different business resource generating templates to adapt to the needs of a complex business resource generating scenario.

S230: Acquire business attribute information input based on a business information input component, and match a business resource generating template based on the business attribute information.

S240: Based on a business attribute information item in the business resource generating template, acquire a business attribute information value corresponding to the business attribute information item, and generate business resource information based on the business attribute information value.

According to the technical solutions of the embodiments of the present disclosure, configuration scenario information input based on a business configuration scenario component is acquired in a business resource generating template configuration page, and a configurable item matching a corresponding configuration scenario is determined based on the configuration scenario information; and a configuration item content input by a configuration input component based on the configurable item is acquired, and the business resource generating template based on the configuration item content is obtained; business attribute information input based on a business information input component is acquired, and a business resource generating template based on the business attribute information is matched; based on a business attribute information item in the business resource generating template, a business attribute information value corresponding to the business attribute information item is acquired, and business resource information is generated based on the business attribute information value. The technical solution of the embodiments of the present disclosure solves the problem of multiple and complex preset business attribute information items maintained separately by a plurality of parties, resulting in complex business resource generating template configuration as well as code maintenance. The business resource generating template configuration may be performed based on the predetermined business attribute information items of the unified data structure, and the business resource generating template may be further configured with a combination of multi-dimensional predetermined business attribute information items to apply to different business resource generating scenarios. So that the business resource generating template configuration is more flexible, reducing the complexity of the maintenance and implementation of the business resource generating template configuration function.

FIG. 3 is a schematic flowchart of a method of business information generation according to an embodiment of the present disclosure. On the basis of the above embodiment, in the process of implementing the method of business information generation, the process regarding the configuration of a predetermined business attribute information item, an attribute information operation identification, and/or an attribute arithmetic function is further explained. The method may be performed by an apparatus for generating business information, which may be implemented in the form of software and/or hardware, and optionally, by an electronic device, which may be a mobile terminal, a PC, or a server, and the like.

As shown in FIG. 3, the method of business information generation includes:

S310: Acquire, on a business attribute information item configuration page, field attribute configuration information input based on an information input component of a predetermined information field attribute configuration item.

The business attribute information item configuration page includes a graphical presentation of the predetermined attribute data structure and a business attribute information item configuration panel, and the business attribute information item configuration panel includes the information input component of the predetermined information field attribute configuration item, wherein the predetermined information field attribute configuration item corresponds to a predetermined attribute data structure of the predetermined business attribute information item.

The predetermined information field attribute configuration item includes at least one of the following: a name of a business attribute information item, a category to which the business attribute information item belongs, a type of the business attribute information item, an available business configuration scenario, a description of the business attribute information item, or a source of a business attribute information value corresponding to the business attribute information item.

The business attribute information value source includes at least one of the following: an input configuration source, a logistics field assignment source, a function return value source, or a predetermined key value information source.

Specifically, the predetermined business attribute information item may be a kind of metadata, and the corresponding metadata includes several basic concepts as T (Type, data type), F (Function function) and OP (Operator operator).

Therein, T is a pre-configured type, such as Bool, ID, scalar, enumeration, string, weight, address, etc. The configuration derivative of T is represented as a TValue, which represents the definition of T in a specific scenario, and includes two elements, T and the manner in which the value is taken. It should be noted that during the use of the business resource generating template, all locations where a predetermined business attribute information item appears are the corresponding TValue.

F, on the other hand, is configured for specific logical processing of data, with a function signature of F ( . . . T)->T, representing N inputs of type T and N outputs of type T. For example, a method that takes the maximum of both, e.g., Max (Scalar, Scalar)->Scalar. F may be configured to derive a representation of FValue, which identifies the definition of F for a specific scenario, which may be expressed as follows: F ( . . . TValue)->TValue . . . TValue)->TValue.

The OP paradigm is (T op T)->Bool, which only supports the binomial operator, and the result of the operator computation is of Bool type (True/False). The specific use of Operator in the corresponding business resource generation scenario may be expressed as (TValue op TValue)->Bool.

Specifically, an information input component corresponding to the predetermined business attribute information is included in the business attribute information item configuration page for the user to configure the corresponding data information.

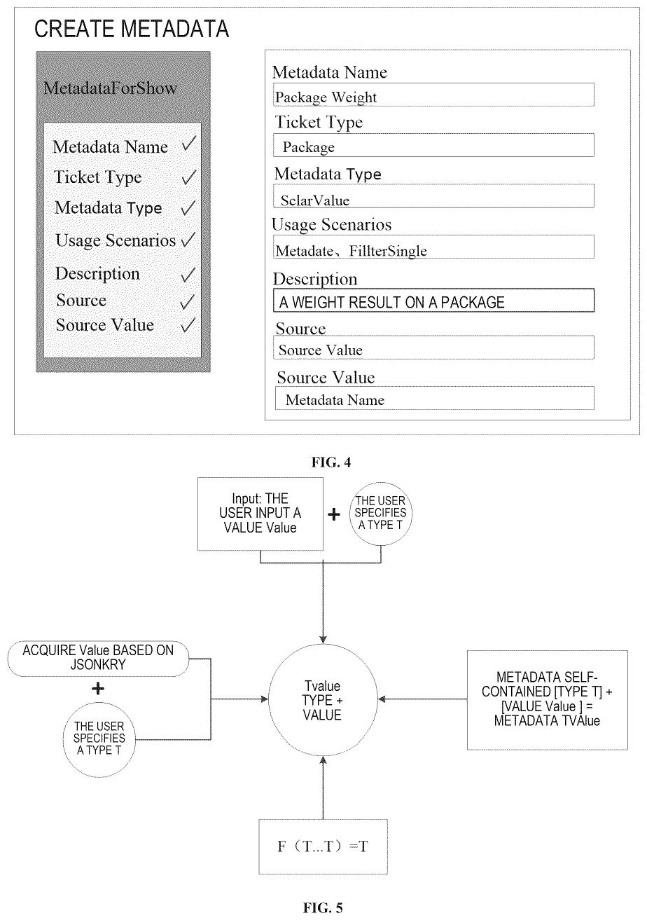

In an optional implementation, the business attribute information item configuration page may refer to the style shown in FIG. 4, including a tree-like graphical presentation of a predetermined attribute data structure on the left and a business attribute information item configuration panel on the right.

S320: Determine the predetermined business attribute information item based on the field attribute configuration information.

For each field attribute configuration information corresponding to a predetermined information field attribute configuration item inputted by the user in the business attribute information item configuration panel, a corresponding marked configured item is correspondingly presented in a graphical presentation of the predetermined attribute data structure on the left side.

In addition, when the business attribute information value source is configured as a function return value source, the configuration process of the predetermined business attribute information item may also present a function configuration page corresponding to the function return value source; on the function configuration page, acquire input function configuration information based on a target function configuration component and a function parameter configuration component, and determine, based on the function configuration information, a configuration result corresponding to the business attribute information value source.

For example, each configuration item in the business attribute information item configuration panel in FIG. 4 corresponds to a node to be configured on the left. In response to a configuration operation in the business attribute information item configuration panel of a field name node (Metadata name), a field belonging to a category node (Ticket Type), a field type node (Metadata Type), an available business configuration scenario node (Usage Scenarios), a field description node (Description), or a source node (Source) of a field value, a corresponding attribute configuration result of the predetermined business attribute information item to be configured may be determined.

The attribute configuration content corresponding to the field value source node includes an input configuration source, a logistics field assignment source, a function return value source, and a predetermined key value information source, representing the source of the field value of the corresponding logistics attribute field in the actual application scenario. The source of the field value corresponding to the predetermined business attribute information item in FIG. 4 may be represented as the source method shown in FIG. 5. A predetermined business attribute information item may be configured with different field value sources under different business configuration scenarios.

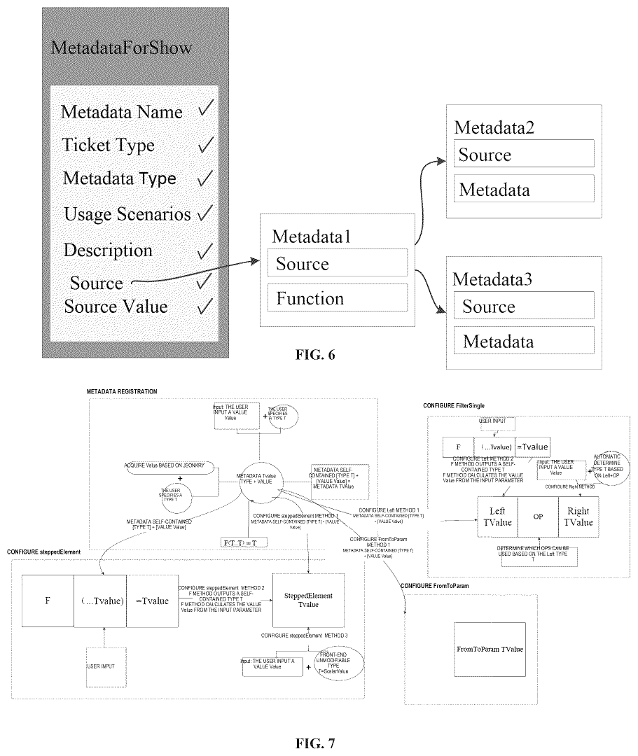

Further, when the field value is configured as a function return value source, representation of a function configuration page corresponding to the function return value source is also automatically triggered. In a function configuration page, in response to a configuration operation on a target function and a function parameter, a numerical source of the function input parameter of the target function is determined, so as to complete a configuration process of a field attribute configuration result corresponding to the field value source node. That is, the user needs to further configure a field value source of the predetermined business attribute information item in the target function, and the entire registration configuration process forms a nested configuration process shown in FIG. 6.

S330: Acquire, in a business resource generating template configuration page, configuration scenario information input based on a business configuration scenario component, and determine, based on the configuration scenario information, a configurable item matching a corresponding configuration scenario.

The configurable item may include a predetermined business attribute information item, an attribute information operation identification and/or an attribute arithmetic function that is configured in the foregoing step and matches the configuration scenario corresponding to the configuration scenario information.

S340: Acquire a configuration item content input by a configuration input component based on the configurable item, and obtain the business resource generating template based on the configuration item content.

In an optional implementation, in the logistics business, the scenarios for performing business resource generating template configuration based on the registered predetermined business attribute information items (logistics attribute field attribute) may be referred to three business configuration scenarios shown in FIG. 7:

A scenario corresponding to the configuration scenario information is a business configuration scenario (configuring a FromToParam) associated with transport start and end addresses in a logistics business, and obtaining the business resource generating template based on the configuration item content may be acquiring a first configuration item content input by an information input component based on a start address information item and an end address information item in the predetermined business attribute information item, and determining a transportation start and end interval of logistics transport based on the first configuration item content; acquiring a second configuration item content input based on an information input component of a business resource reference information item in the predetermined business attribute information item, and determining a business resource reference information value; and based on the transportation start and end interval and the business resource reference information value, determining a business resource generating template corresponding to the transportation start and end interval.

A scenario corresponding to the configuration scenario information is a business configuration scenario (configuring a Stepped Element) associated with a business resource identification in a logistics business, and obtaining the business resource generating template based on the configuration item content may be acquiring a configuration item content input based on an information input component of a predetermined business attribute information item in the configurable item, and determining a business resource targeted object based on the configuration item content; acquiring a source information value based on a business attribute information value source configuration input component of the business resource targeted object, and determining a business attribute information value source of the business resource targeted object; and acquiring operation identification input information of an input control of the attribute information operation identification corresponding to the business resource targeted object, and determining a business resource generating template corresponding to the business resource targeted object based on the operation identification input information and the business attribute information value.

A scenario corresponding to the configuration scenario information is a business configuration scenario (configuration FilterSingle) associated with resource information filtering in a logistics business, and obtaining the business resource generating template based on the configuration item content may be acquiring a configuration item content input based on an information input component of a predetermined business attribute information item in the configurable item, determining a resource information filtering object based on the configuration item content, and determining the selectable attribute information operation identification based on the resource information filtering object; in response to a selection operation on the optional attribute information operation identification, determining a target attribute information operation identification, and presenting an input control of a resource information filtering condition value corresponding to the target attribute information operation identification; wherein the input control of the resource information filtering condition value presents a category to which a business attribute information item belongs, which matches a combined result of the resource information filtering object and the target attribute information operation identification; and determining an information filtering condition value of the resource information filtering object based on filtering condition information that is input based on the input control of the resource information filtering condition value, and determining a business resource generating template corresponding to the resource information filtering object based on the information filtering condition value.

S350: Obtain template application configuration information input based on a template application component.

S360: Determine, based on the template application configuration information, an application logic relationship between at least two different business resource generating templates, and obtaining a new business resource generating template based on the application logic relationship.

For example, the business resource generating templates from the plurality of FilterSingle scenarios are combined buy obtaining a new business resource generating template.

S370: Acquire business attribute information input based on a business information input component, and match a business resource generating template based on the business attribute information.

The business attribute information includes a corresponding business attribute information item and a business attribute information value, and the business resource generating template is configured and generated based on at least one of the following: a predetermined business attribute information item, an attribute information operation identification, or an attribute arithmetic function in the above step.

S380: Based on a business attribute information item in the business resource generating template, acquire a business attribute information value corresponding to the business attribute information item, and generate business resource information based on the business attribute information value.

The predetermined business attribute information item is pre-configured based on a predetermined attribute data structure; the attribute arithmetic function is pre-constructed based on the predetermined business attribute information item; and the attribute information operation identification is configured to indicate that an arithmetic operation corresponding to the attribute information operation identification is performed on a business attribute information value of a predetermined business attribute information item corresponding to the attribute information operation identification.

The technical solutions of the embodiments of the present disclosure includes: acquiring, on a business attribute information item configuration page, field attribute configuration information input based on an information input component of a predetermined information field attribute configuration item; determining the predetermined business attribute information item based on the field attribute configuration information; acquiring, in a business resource generating template configuration page, configuration scenario information input based on a business configuration scenario component, and determining, based on the configuration scenario information, a configurable item matching a corresponding configuration scenario; and acquiring a configuration item content input by a configuration input component based on the configurable item, and obtaining the business resource generating template based on the configuration item content; obtaining template application configuration information input based on a template application component; and determining, based on the template application configuration information, an application logic relationship between at least two different business resource generating templates, and obtaining a new business resource generating template based on the application logic relationship; acquiring business attribute information input based on a business information input component, and matching a business resource generating template based on the business attribute information; based on a business attribute information item in the business resource generating template, acquiring a business attribute information value corresponding to the business attribute information item, and generating business resource information based on the business attribute information value. The technical solution of the embodiments of the present disclosure solves the problem of multiple and complex preset business attribute information items maintained separately by a plurality of parties, resulting in complex business resource generating template configuration as well as code maintenance. The business resource generating template configuration may be performed based on the predetermined business attribute information items of the unified data structure, and the business resource generating template may be further configured with a combination of multi-dimensional predetermined business attribute information items to apply to different business resource generating scenarios. So that the business resource generating template configuration is more flexible, reducing the complexity of the maintenance and implementation of the business resource generating template configuration function.

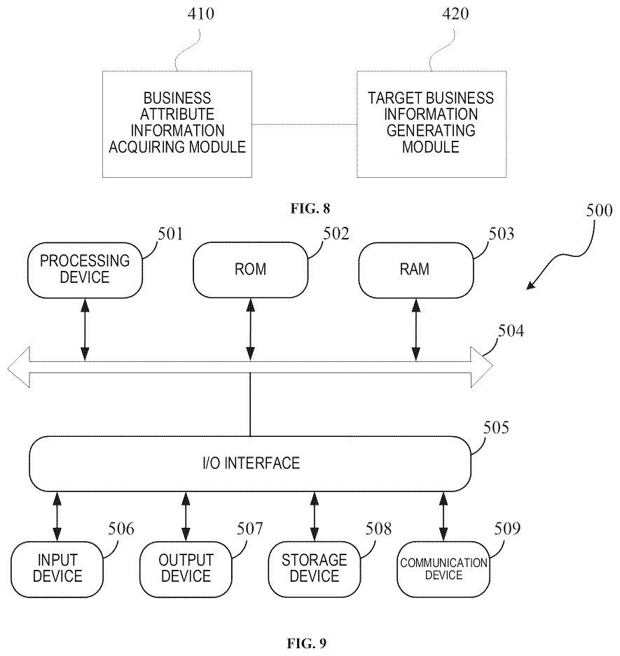

FIG. 8 is an apparatus for generating business information provided in an embodiment of the present disclosure. The apparatus is suitable for a scenario where the target business information is confirmed based on business attribute information in a plurality of dimensions, and the apparatus for generating business information may be implemented in the form of software and/or hardware that may be configured in an electronic device, which may be a mobile terminal, a PC, or a server, and the like.

As shown in FIG. 8, the apparatus for generating business information includes a business attribute information acquiring module 410 and a target business information generating module 420.

The business attribute information acquiring module 410 is configured to acquire business attribute information input based on a business information input component, and match a business resource generating template based on the business attribute information; wherein the business attribute information includes a corresponding business attribute information item and a business attribute information value; the target business information generating module 420 is configured to acquire, based on a business attribute information item in the business resource generating template, a business attribute information value corresponding to the business attribute information item, and generate business resource information based on the business attribute information value; wherein the business resource generating template is configured and generated based on at least one of the following: a predetermined business attribute information item, an attribute information operation identification, or an attribute arithmetic function; the predetermined business attribute information item is pre-configured based on a predetermined attribute data structure; the attribute arithmetic function is pre-constructed based on the predetermined business attribute information item; and the attribute information operation identification is configured to indicate that an arithmetic operation corresponding to the attribute information operation identification is performed on a business attribute information value of a predetermined business attribute information item corresponding to the attribute information operation identification.

According to the technical solutions of the embodiments of the present disclosure, business attribute information input based on a business information input component is acquired, and a business resource generating template is matched based on the business attribute information; wherein the business attribute information includes a corresponding business attribute information item and a business attribute information value; and based on a business attribute information item in the business resource generating template, a business attribute information value corresponding to the business attribute information item is acquired, and business resource information is generated based on the business attribute information value; wherein the business resource generating template is configured and generated based on at least one of the following: a predetermined business attribute information item, an attribute information operation identification, or an attribute arithmetic function. The technical solution of the embodiments of the present disclosure solves the problem of complex configuration and maintenance of business information generation templates, and may configure resource generation templates based on pre-configured business attribute metadata for generating business resource information, which improves the efficiency of acquiring business information, and also reduces the complexity of implementing the business resource templates configuration and the maintenance of related data.

In an optional implementation, the apparatus for generating business information may further include a template configurating module, specifically configured to configure and generate a business resource generating template, wherein the configuration process of the business resource generating template includes the following steps:
acquiring, in a business resource generating template configuration page, configuration scenario information input based on a business configuration scenario component, and determining, based on the configuration scenario information, a configurable item matching a corresponding configuration scenario; and acquiring a configuration item content input by a configuration input component based on the configurable item, and obtaining the business resource generating template based on the configuration item content; wherein the configurable item includes a predetermined business attribute information item, an attribute information operation identification and/or an attribute arithmetic function that matches a configuration scenario corresponding to the configuration scenario information.

In an optional implementation, the template configurating module may be further configured to: obtain template application configuration information input based on a template application component; and determine, based on the template application configuration information, an application logic relationship between at least two different business resource generating templates, and obtain a new business resource generating template based on the application logic relationship.

In an optional implementation, the apparatus for generating business information may further include a business attribute information item configurating module, specifically configured to configure a predetermined business attribute information item. The configuration process of the predetermined business attribute information items includes the following steps: acquiring, on a business attribute information item configuration page, field attribute configuration information input based on an information input component of a predetermined information field attribute configuration item; wherein the predetermined information field attribute configuration item corresponds to the predetermined attribute data structure; and determining the predetermined business attribute information item based on the field attribute configuration information; wherein the business attribute information item configuration page includes a graphical presentation of the predetermined attribute data structure and a business attribute information item configuration panel, and the business attribute information item configuration panel includes the information input component of the predetermined information field attribute configuration item.

In an optional implementation, the predetermined information field attribute configuration item includes at least one of the following: a name of a business attribute information item, a category to which the business attribute information item belongs, a type of the business attribute information item, an available business configuration scenario, a description of the business attribute information item, or a source of a business attribute information value corresponding to the business attribute information item.

In an optional implementation, the business attribute information value source includes at least one of the following: an input configuration source, a logistics field assignment source, a function return value source, or a predetermined key value information source.

In an optional implementation, the business attribute information item configurating module may be further configured to: when the business attribute information value source is configured to be the function return value source, present a function configuration page corresponding to the function return value source; on the function configuration page, acquire input function configuration information based on a target function configuration component and a function parameter configuration component, and determine, based on the function configuration information, a configuration result corresponding to the business attribute information value source.

In an optional implementation, a scenario corresponding to the configuration scenario information is a business configuration scenario associated with transport start and end addresses in a logistics business, and the template configurating module may be specifically configured to: acquire a first configuration item content input by an information input component based on a start address information item and an end address information item in the predetermined business attribute information item, and determine a transportation start and end interval of logistics transport based on the first configuration item content; acquire a second configuration item content input based on an information input component of a business resource reference information item in the predetermined business attribute information item, and determine a business resource reference information value; and based on the transportation start and end interval and the business resource reference information value, determine a business resource generating template corresponding to the transportation start and end interval.

In an optional implementation, a scenario corresponding to the configuration scenario information is a business configuration scenario associated with a business resource identification in a logistics business, and the template configurating module may be specifically configured to: acquire a configuration item content input based on an information input component of a predetermined business attribute information item in the configurable item, and determine a business resource targeted object based on the configuration item content; acquire a source information value based on a business attribute information value source configuration input component of the business resource targeted object, and determine a business attribute information value source of the business resource targeted object; and acquire operation identification input information of an input control of the attribute information operation identification corresponding to the business resource targeted object, and determine a business resource generating template corresponding to the business resource targeted object based on the operation identification input information and the business attribute information value.

In an optional implementation, a scenario corresponding to the configuration scenario information is a business configuration scenario associated with resource information filtering in a logistics business, and the template configurating module may be specifically configured to: acquire a configuration item content input based on an information input component of a predetermined business attribute information item in the configurable item, determine a resource information filtering object based on the configuration item content, and determining the selectable attribute information operation identification based on the resource information filtering object; in response to a selection operation on the optional attribute information operation identification, determine a target attribute information operation identification, and present an input control of a resource information filtering condition value corresponding to the target attribute information operation identification; wherein the input control of the resource information filtering condition value presents a category to which a business attribute information item belongs, which matches a combined result of the resource information filtering object and the target attribute information operation identification; and determine an information filtering condition value of the resource information filtering object based on filtering condition information that is input based on the input control of the resource information filtering condition value, and determine a business resource generating template corresponding to the resource information filtering object based on the information filtering condition value.

The apparatus for generating business information provided in the embodiments of the present disclosure may perform the method of business information generation provided in any embodiment of the present disclosure and has functional modules and beneficial effects for performing the method.

FIG. 9 is a schematic structural diagram of an electronic device according to an embodiment of the present disclosure. FIG. 9 is a schematic structural diagram of an electronic device 500 (such as the terminal device or server in FIG. 9) suitable for implementing the embodiments of the present disclosure. The terminal device in embodiments of the present disclosure may include, but are not limited to, a mobile terminal such as a mobile phone, a notebook computer, a digital broadcast receiver, a PDA (personal digital assistant), a PAD (tablet computer), a PMP (portable multimedia player), an in-vehicle terminal (for example, an in-vehicle navigation terminal), and a fixed terminal such as a digital TV, a desktop computer, or the like. The electronic device shown in FIG. 9 is only an example and shall not impose any limitation on the functionality and scope of use of the embodiment of the present disclosure.

As shown in FIG. 9, the electronic device 500 may include a processing device (for example, a central processing unit, a graphics processor, etc.) 501, which may perform various appropriate actions and processing according to a program stored in a read-only memory (ROM) 502 or a program loaded into a random access memory (RAM) 503 from a storage device 508. In the RAM 503, various programs and data required by the operation of the electronic device 500 are also stored. The processing device 501, the ROM 502, and the RAM 503 are connected to each other through a bus 504. An edit/output (I/O) interface 505 is also connected to the bus 505.

Generally, the following devices may be connected to the I/O interface 505: an input device such as a touch screen, touch pad, keyboard, mouse, camera, microphone, accelerometer, gyroscope, etc. 506; an output device including, for example, a liquid crystal display (LCD), loudspeaker, vibrator, etc. 507; a storage device, such as magnetic tape, hard disk, etc. 508; and a communication device 509. The communication device 509 may allow the electronic device 500 to communicate wirelessly or wirelessly with other devices to exchange data. Although FIG. 9 shows the electronic device 500 with various devices, it would be appreciated that the implementation or availability of all the devices shown is not required. It is possible to implement or have more or fewer devices instead.

In particular, according to an embodiment of the present disclosure, the process described above with reference to the flowchart may be implemented as a computer software program. For example, an embodiment of the present disclosure includes a computer program product including a computer program carried on a non-transitory computer readable medium. The computer program include program code for performing a method shown in the flow chart. In such an embodiment, the computer program may be downloaded and installed from the network by means of the communication device 509, or from the storage device 508, or from the ROM 502. When the computer program is executed by the processing device 501, the above functions defined in the methods of the embodiments are performed.

The names of messages or information exchanged between the plurality of devices in embodiments of the present disclosure are for illustrative purposes only and are not intended to limit the scope of such messages or information.

The electronic device provided by the embodiments of the present disclosure and the method of business information generation provided in the foregoing embodiments belong to the same inventive concept. Technical details not exhaustively described in this embodiment may be found in the above embodiment, and this embodiment has the same beneficial effects as the above embodiment.

An embodiment of the present disclosure provides a computer storage medium having a computer program stored thereon, the program, when executed by a processor, implements the method of business information generation provided in the foregoing embodiments.

It would be noted that the computer-readable medium described above may be a computer readable signal medium, a computer readable storage medium, or any combination of the foregoing two. The computer-readable storage medium may be, for example, but not limited to, an electrical, magnetic, optical, electromagnetic, infrared, or semiconductor system, apparatus, or device, or any combination thereof. More specific examples of computer-readable storage media may include but are not limited to: an electrical connection having one or more wires, a portable computer diskette, a hard disk, a random access memory (RAM), a read-only memory (ROM), an erasable programmable read-only memory (EPROM or Flash memory), an optical fiber, a portable compact disk read-only memory (CD-ROM), an optical storage device, a magnetic storage device, or any suitable combination of the foregoing. In the present disclosure, a computer-readable storage medium may be any tangible medium containing or storing a program that may be used by or in connection with an instruction execution system, apparatus, or appliance. In the present disclosure, a computer readable signal medium may include a data signal propagated in baseband or as part of a carrier, wherein the computer readable program code is carried. Such propagated data signals may take a variety of forms including, but not limited to, electromagnetic signals, optical signals, or any suitable combination of the foregoing. The computer readable signal medium may also be any computer readable medium other than a computer readable storage medium that may send, propagate, or transmit a program for use by or in connection with an instruction execution system, apparatus, or appliance. The program code embodied on the computer-readable medium may be transmitted with any suitable medium, including, but not limited to, wires, optical cables, RF (radio frequency), and the like, or any suitable combination of the foregoing.

In some implementations, the client, server may communicate using any currently known or future developed network protocol, such as HTTP (HyperText Transfer Protocol), and may be interconnected with any form or medium of digital data communication (e.g., a communication network). Examples of communication networks include local area network (‘LAN’), wide area network (‘WAN’), internets (e.g., the Internet), and peer-to-peer networks (e.g., ad hoc peer-to-peer networks), as well as any currently known or future developed networks.

The computer-readable medium described above may be included in the electronic device; or may be separately present without being assembled into the electronic device.

The computer-readable medium carries one or more programs, and when the one or more programs are executed by the electronic device, the electronic device is caused to: acquire business attribute information input based on a business information input component, and match a business resource generating template based on the business attribute information; wherein the business attribute information includes a corresponding business attribute information item and a business attribute information value; and based on a business attribute information item in the business resource generating template, acquire a business attribute information value corresponding to the business attribute information item, and generate business resource information based on the business attribute information value; wherein the business resource generating template is configured and generated based on at least one of the following: a predetermined business attribute information item, an attribute information operation identification, or an attribute arithmetic function; the predetermined business attribute information item is pre-configured based on a predetermined attribute data structure; the attribute arithmetic function is pre-constructed based on the predetermined business attribute information item; and the attribute information operation identification is configured to indicate that an arithmetic operation corresponding to the attribute information operation identification is performed on a business attribute information value of a predetermined business attribute information item corresponding to the attribute information operation identification.

Computer program code for performing the operations of the present disclosure may be written in one or more programming languages, including, but not limited to, object oriented programming languages such as Java, Smalltalk, C++, and conventional procedural programming languages, such as the ‘C’ language or similar programming languages. The program code may execute entirely on a user computer, partially on a user computer, as a stand-alone software package, partially on a user computer, partially on a remote computer, or entirely on a remote computer or server. In the case of a remote computer, the remote computer may be connected to the user computer through any kind of network, including a local area network (LAN) or a wide area network (WAN), or may be connected to an external computer (e.g., connected through the Internet using an Internet service provider).

The flowcharts and block diagrams in the figures illustrate architecture, function, and operation of possible implementations of systems, methods, and computer program products according to various embodiments of the present disclosure. In this regard, each block in the flowchart or block diagram may represent a module, program segment, or portion of code that includes one or more executable instructions for implementing the specified logical function. It would also be noted that in some alternative implementations, the functions noted in the blocks may also occur in a different order than that illustrated in the figures. For example, two consecutively represented blocks may actually be performed substantially in parallel, which may sometimes be performed in the reverse order, depending on the function involved. It is also noted that each block in the block diagrams and/or flowcharts, as well as combinations of blocks in the block diagrams and/or flowcharts, may be implemented with a dedicated hardware-based system that performs the specified functions or operations, or may be implemented in a combination of dedicated hardware and computer instructions.

The units involved in the embodiments of the present disclosure may be implemented in software, or may be implemented in hardware. Therein, the name of a unit does not qualify the unit itself in some way, for example, the first obtaining unit may be further described as ‘obtaining at least two units of Internet Protocol addresses’.

The functions described above may be performed, at least in part, by one or more hardware logic components. For example, without limitation, example types of hardware logic components that may be used including: field programmable gate arrays (FPGAs), application specific integrated circuits (ASICs), application specific standard products (ASSPs), system-on-a-chip (SOCs), complex programmable logic devices (CPLDs), and the like.

In the context of the present disclosure, a machine-readable medium may be a tangible medium that may contain or store a program for use by or in connection with an instruction execution system, apparatus, or device. The machine-readable medium may be a machine-readable signal medium or a machine-readable storage medium. The machine-readable medium may include, but is not limited to, electronic, magnetic, optical, electromagnetic, infrared, or semiconductor systems, apparatuses, or devices, or any suitable combination of the foregoing. More specific examples of machine-readable storage media may include electrical connections based on one or more lines, portable computer disks, hard disks, random access memory (RAM), read-only memory (ROM), erasable programmable read-only memory (EPROM or Flash memory), optical fibers, portable compact disc read-only memory (CD-ROM), optical storage devices, magnetic storage devices, or any suitable combination of the foregoing.

The embodiments of the present disclosure also provide a computer program product including a computer program, which, when executed by a processor, implements a method of generating business information as provided in any of the embodiments of the present disclosure.

During implementation of the computer program product, the computer program code for performing the operations of the present disclosure may be written in one or more programming languages or a combination thereof. The programming languages include an object oriented programming language, such as Java, Smalltalk, C++ or the like, and conventional procedural programming languages, such as the ‘C’ programming language or similar programming languages. The program code may be executed entirely on the computer of the user, partially on the computer of the user, as a stand-alone software package, partially on the computer of the user and partially on a remote computer, or entirely on a remote computer or server. In the case involving a remote computer, the remote computer may be connected to the user computer via any kind of network—including a local area network (LAN) or a wide area network (WAN)—or, alternatively, it may be connected to an external computer (e.g., by utilizing an Internet service provider to connect via the Internet).

The description above is merely an illustration of the preferred embodiments of the present disclosure and the principles of the application. It would be appreciated by those skilled in the art that the disclosure in the present disclosure is not limited to the technical solutions of the specific combination of the above technical features and would also cover other technical solutions formed by any combination of the above technical features or their equivalent features without departing from the above disclosed concept. For example, the above features are the technical solutions formed by mutually replacing technical features disclosed in the present disclosure (but not limited to).

Further, while operations are depicted in a particular order, this would not be appreciated to require that these operations be performed in the particular order shown or in sequential order. In certain circumstances, multitasking and parallel processing may be advantageous. Likewise, while several specific implementation details are included in the discussion above, these would not be construed as limiting the scope of the present disclosure. Certain features described in the context of separate embodiments may also be implemented in combination in a single embodiment. Conversely, the various features described in the context of a single embodiment may also be implemented in multiple embodiments either individually or in any suitable sub-combination.

Although the present subject matter has been described in language specific to structural features and/or methodological acts, it is to be appreciated that the subject matter defined in the appended claims is not necessarily limited to the specific features or acts described above. Rather, the specific features and acts described above are merely exemplary forms of implementing the claims.

What is claimed is:

1. A method of business information generation, comprising:
acquiring business attribute information input based on a business information input component, and matching a business resource generating template based on the business attribute information; wherein the business attribute information comprises a corresponding business attribute information item and a business attribute information value; and
based on a business attribute information item in the business resource generating template, acquiring a business attribute information value corresponding to the business attribute information item, and generating business resource information based on the business attribute information value;
wherein the business resource generating template is configured and generated based on at least one of the following: a predetermined business attribute information item, an attribute information operation identification, or an attribute arithmetic function; and
wherein the predetermined business attribute information item is pre-configured based on a predetermined attribute data structure; the attribute arithmetic function is pre-constructed based on the predetermined business attribute information item; and the attribute information operation identification is configured to indicate that an arithmetic operation corresponding to the attribute information operation identification is performed on a business attribute information value of a predetermined business attribute information item corresponding to the attribute information operation identification.

2. The method of claim 1, wherein a configuration process of the business resource generating template comprises:
acquiring, in a business resource generating template configuration page, configuration scenario information input based on a business configuration scenario component, and determining, based on the configuration scenario information, a configurable item matching a corresponding configuration scenario; and
acquiring a configuration item content input by a configuration input component based on the configurable item, and obtaining the business resource generating template based on the configuration item content;
wherein the configurable item includes a predetermined business attribute information item, an attribute information operation identification and/or an attribute arithmetic function that matches a configuration scenario corresponding to the configuration scenario information.

3. The method of claim 2, wherein the configuration process of the business resource generating template further comprises:
obtaining template application configuration information input based on a template application component; and
determining, based on the template application configuration information, an application logic relationship between at least two different business resource generating templates, and obtaining a new business resource generating template based on the application logic relationship.

4. The method of claim 1, wherein a configuration process of the predetermined business attribute information item comprises:
acquiring, on a business attribute information item configuration page, field attribute configuration information input based on an information input component of a predetermined information field attribute configuration item; wherein the predetermined information field attribute configuration item corresponds to the predetermined attribute data structure; and
determining the predetermined business attribute information item based on the field attribute configuration information;
wherein the business attribute information item configuration page comprises a graphical presentation of the predetermined attribute data structure and a business attribute information item configuration panel, and the business attribute information item configuration panel comprises the information input component of the predetermined information field attribute configuration item.

5. The method of claim 4, wherein the predetermined information field attribute configuration item comprises at least one of the following:
a name of a business attribute information item,
a category to which the business attribute information item belongs,
a type of the business attribute information item,
an available business configuration scenario,
a description of the business attribute information item, or
a source of a business attribute information value corresponding to the business attribute information item.

6. The method of claim 5, wherein the business attribute information value source comprises at least one of the following:
an input configuration source,
a logistics field assignment source,
a function return value source, or
a predetermined key value information source.

7. The method of claim 6, wherein when the business attribute information value source is configured to be the function return value source, the configuration process of the predetermined business attribute information item further comprises:
presenting a function configuration page corresponding to the function return value source; and
on the function configuration page, acquiring input function configuration information based on a target function configuration component and a function parameter configuration component, and determining, based on the function configuration information, a configuration result corresponding to the business attribute information value source.

8. The method of claim 2, wherein a scenario corresponding to the configuration scenario information is a business configuration scenario associated with transport start and end addresses in a logistics business, and obtaining the business resource generating template based on the configuration item content comprises:
acquiring a first configuration item content input by an information input component based on a start address information item and an end address information item in the predetermined business attribute information item, and determining a transportation start and end interval of logistics transport based on the first configuration item content;
acquiring a second configuration item content input based on an information input component of a business resource reference information item in the predetermined business attribute information item, and determining a business resource reference information value; and
based on the transportation start and end interval and the business resource reference information value, determining a business resource generating template corresponding to the transportation start and end interval.

9. The method of claim 2, wherein a scenario corresponding to the configuration scenario information is a business configuration scenario associated with a business resource identification in a logistics business, and obtaining the business resource generating template based on the configuration item content comprises:
acquiring a configuration item content input based on an information input component of a predetermined business attribute information item in the configurable item, and determining a business resource targeted object based on the configuration item content;
acquiring a source information value based on a business attribute information value source configuration input component of the business resource targeted object, and determining a business attribute information value source of the business resource targeted object; and
acquiring operation identification input information of an input control of the attribute information operation identification corresponding to the business resource targeted object, and determining a business resource generating template corresponding to the business resource targeted object based on the operation identification input information and the business attribute information value.

10. The method of claim 2, wherein a scenario corresponding to the configuration scenario information is a business configuration scenario associated with resource information filtering in a logistics business, and obtaining the business resource generating template based on the configuration item content comprises:
acquiring a configuration item content input based on an information input component of a predetermined business attribute information item in the configurable item, determining a resource information filtering object based on the configuration item content, and determining the selectable attribute information operation identification based on the resource information filtering object;
in response to a selection operation on the optional attribute information operation identification, determining a target attribute information operation identification, and presenting an input control of a resource information filtering condition value corresponding to the target attribute information operation identification; wherein the input control of the resource information filtering condition value presents a category to which a business attribute information item belongs, which matches a combined result of the resource information filtering object and the target attribute information operation identification; and
determining an information filtering condition value of the resource information filtering object based on filtering condition information that is input based on the input control of the resource information filtering condition value, and determining a business resource generating template corresponding to the resource information filtering object based on the information filtering condition value.

11. An electronic device, comprising:
one or more processors; and
a storage device for storing one or more programs,
the one or more programs, when executed by the one or more processors, causing the one or more processors to perform acts comprising:
acquiring business attribute information input based on a business information input component, and matching a business resource generating template based on the business attribute information; wherein the business attribute information comprises a corresponding business attribute information item and a business attribute information value; and
based on a business attribute information item in the business resource generating template, acquiring a business attribute information value corresponding to the business attribute information item, and generating business resource information based on the business attribute information value;
wherein the business resource generating template is configured and generated based on at least one of the following: a predetermined business attribute information item, an attribute information operation identification, or an attribute arithmetic function; and
wherein the predetermined business attribute information item is pre-configured based on a predetermined attribute data structure; the attribute arithmetic function is pre-constructed based on the predetermined business attribute information item; and the attribute information operation identification is configured to indicate that an arithmetic operation corresponding to the attribute information operation identification is performed on a business attribute information value of a predetermined business attribute information item corresponding to the attribute information operation identification.

12. The electronic device of claim 11, wherein a configuration process of the business resource generating template comprises:
acquiring, in a business resource generating template configuration page, configuration scenario information input based on a business configuration scenario component, and determining, based on the configuration scenario information, a configurable item matching a corresponding configuration scenario; and
acquiring a configuration item content input by a configuration input component based on the configurable item, and obtaining the business resource generating template based on the configuration item content;
wherein the configurable item includes a predetermined business attribute information item, an attribute information operation identification and/or an attribute arithmetic function that matches a configuration scenario corresponding to the configuration scenario information.

13. The electronic device of claim 12, wherein the configuration process of the business resource generating template further comprises:
obtaining template application configuration information input based on a template application component; and
determining, based on the template application configuration information, an application logic relationship between at least two different business resource generating templates, and obtaining a new business resource generating template based on the application logic relationship.

14. The electronic device of claim 11, wherein a configuration process of the predetermined business attribute information item comprises:
acquiring, on a business attribute information item configuration page, field attribute configuration information input based on an information input component of a predetermined information field attribute configuration item; wherein the predetermined information field attribute configuration item corresponds to the predetermined attribute data structure; and
determining the predetermined business attribute information item based on the field attribute configuration information;
wherein the business attribute information item configuration page comprises a graphical presentation of the predetermined attribute data structure and a business attribute information item configuration panel, and the business attribute information item configuration panel comprises the information input component of the predetermined information field attribute configuration item.

15. The electronic device of claim 14, wherein the predetermined information field attribute configuration item comprises at least one of the following:
a name of a business attribute information item,
a category to which the business attribute information item belongs,
a type of the business attribute information item,
an available business configuration scenario,
a description of the business attribute information item, or
a source of a business attribute information value corresponding to the business attribute information item.

16. The electronic device of claim 15, wherein the business attribute information value source comprises at least one of the following:
an input configuration source,
a logistics field assignment source,
a function return value source, or
a predetermined key value information source.

17. The electronic device of claim 16, wherein when the business attribute information value source is configured to be the function return value source, the configuration process of the predetermined business attribute information item further comprises:
presenting a function configuration page corresponding to the function return value source; and
on the function configuration page, acquiring input function configuration information based on a target function configuration component and a function parameter configuration component, and determining, based on the function configuration information, a configuration result corresponding to the business attribute information value source.

18. The electronic device of claim 12, wherein a scenario corresponding to the configuration scenario information is a business configuration scenario associated with transport start and end addresses in a logistics business, and obtaining the business resource generating template based on the configuration item content comprises:
acquiring a first configuration item content input by an information input component based on a start address information item and an end address information item in the predetermined business attribute information item, and determining a transportation start and end interval of logistics transport based on the first configuration item content;
acquiring a second configuration item content input based on an information input component of a business resource reference information item in the predetermined business attribute information item, and determining a business resource reference information value; and
based on the transportation start and end interval and the business resource reference information value, determining a business resource generating template corresponding to the transportation start and end interval.

19. The electronic device of claim 12, wherein a scenario corresponding to the configuration scenario information is a business configuration scenario associated with a business resource identification in a logistics business, and obtaining the business resource generating template based on the configuration item content comprises:
acquiring a configuration item content input based on an information input component of a predetermined business attribute information item in the configurable item, and determining a business resource targeted object based on the configuration item content;
acquiring a source information value based on a business attribute information value source configuration input component of the business resource targeted object, and determining a business attribute information value source of the business resource targeted object; and
acquiring operation identification input information of an input control of the attribute information operation identification corresponding to the business resource targeted object, and determining a business resource generating template corresponding to the business resource targeted object based on the operation identification input information and the business attribute information value.

20. A non-transitory computer readable storage medium having a computer program stored thereon, wherein the program, when executed by a processor, performs acts comprising:
acquiring business attribute information input based on a business information input component, and matching a business resource generating template based on the business attribute information; wherein the business attribute information comprises a corresponding business attribute information item and a business attribute information value; and
based on a business attribute information item in the business resource generating template, acquiring a business attribute information value corresponding to the business attribute information item, and generating business resource information based on the business attribute information value;
wherein the business resource generating template is configured and generated based on at least one of the following: a predetermined business attribute information item, an attribute information operation identification, or an attribute arithmetic function; and
wherein the predetermined business attribute information item is pre-configured based on a predetermined attribute data structure; the attribute arithmetic function is pre-constructed based on the predetermined business attribute information item; and the attribute information operation identification is configured to indicate that an arithmetic operation corresponding to the attribute information operation identification is performed on a business attribute information value of a predetermined business attribute information item corresponding to the attribute information operation identification.
